(19) United States
(12) Patent Application Publication
(10) Pub. No.: US 2026/0017022 A1
(43) Pub. Date: Jan. 15, 2026

(54) ENHANCED INTEGER ENCODING FOR ARITHMETIC PROCESSORS

(71) Applicant: International Business Machines Corporation, Armonk, NY (US)

(72) Inventors: Monodeep Kar, Yorktown Heights, NY (US); Ankur Agrawal, Chappaqua, NY (US); Andrea Fasoli, San Jose, CA (US)

(73) Assignee: International Business Machines Corporation, Armonk, NY (US)

(21) Appl. No.: 18/768,500

(22) Filed: Jul. 10, 2024

(51) Int. Cl. G06F 7/74

(52) U.S. Cl. CPC G06F 7/74

(57) ABSTRACT

A processing unit includes a processing element (PE) array having a plurality of rows of PEs and a plurality of columns of PEs. Each of the PEs includes an arithmetic circuit configured to mathematically combine activation operands and weight operands. The PE array also includes a weight memory configured to supply weight operands to PEs in the PE array, an activation memory configured to supply activation operands to PEs in the PE array, and an encoder coupled to the activation memory. The encoder includes a multiplexing circuit configured to encode a signed N-bit input activation as a signed N-M bit higher order portion representing the integer value [signed {a_{N-1} . . . a_{N-M}}+a_{N-1}]*2^{M} and a signed M+1 bit lower order portion representing the integer value signed {a_{N}a_{N-M-1} . . . a₀}.

### BACKGROUND OF THE INVENTION

The present application relates generally to data processing and to parallel processing architectures. More particularly, the present application relates to arrays or grids of processing elements used for applications such as neural networks, image processing, and scientific computing.

Neural networks are a type of machine learning (ML) system inspired by biological neural networks. They are used to estimate or approximate functions that can depend on a large number of inputs. Neural networks have been successful in many fields including computer vision, speech recognition, natural language processing, and data mining.

A typical neural network consists of an interconnected group of artificial neurons or nodes. In a feed-forward neural network, the nodes are organized into layers including an input layer, one or more hidden layers, and an output layer. Each node receives inputs either from the original data (for the input layer) or from the outputs of nodes in the previous layer. It performs a simple operation on the inputs, such as a weighted sum, and optionally followed by a non-linear function. The outputs from each node are then passed on to nodes in the subsequent layer. This feed-forward process continues until outputs from the final layer are produced.

Many neural network implementations utilize a grid or array of simple processing elements (PEs) to accelerate the computations involved. Each PE performs multiplications between input activation values and weight values, accumulates the products, applies a non-linear function, and outputs the result.

The activation values and weights are typically stored in separate memory blocks accessible to the PEs. An activation memory stores encoded activation values that are inputs to the PEs. Similarly, a weight memory stores the weight values used by the PEs for the multiplication operations.

During operation, a controller sequences through cycling the activation and weight values into the PE array so that outputs can be efficiently produced in a parallel, systolic manner. The results from the PE grid can then be used as inputs to another layer or to produce final outputs if operating on the last layer.

There is a continuing need for efficient hardware architectures and mechanisms for implementing neural networks and similar data processing systems using grids of processing elements. Ideally, such architectures should achieve a desired balance between compact implementation, computational throughput, and power management.

### SUMMARY OF THE INVENTION

In view of the foregoing, the present application appreciates that it would be advantageous and desirable to provide improved hardware architectures for arithmetic processing and improved techniques of encoding integer operands for parallel processing.

In at least one embodiment, a processing unit includes a processing element (PE) array having a plurality of rows of PEs and a plurality of columns of PEs. Each of the PEs includes an arithmetic circuit configured to mathematically combine activation operands and weight operands. The PE array also includes a weight memory configured to supply weight operands to PEs in the PE array, an activation memory configured to supply activation operands to PEs in the PE array, and an encoder coupled to the activation memory. The encoder includes a multiplexing circuit configured to encode a signed N-bit input activation as a signed N-M bit higher order portion representing the integer value [signed {a_{N-1} . . . a_{N-M}}+a_{N-1}]*2^{M} and a signed M+1 bit lower order portion representing the integer value signed {a_{N}a_{N-M-1} . . . a₀}.

In some embodiments, the encoder includes a controller configured to selectively control encoding of the signed N-bit input activation by the encoder based on control information.

In some embodiments, the processing unit includes a special function unit circuit configured to determine computation statistics for the PE array, and the control information includes the computation statistics. In some embodiments, the control information includes a software-generated signal.

In some embodiments, the computation statistics include a percentage of operands having a magnitude that satisfies an encoding threshold.

In some embodiments, the signed N-bit input activation can be, for example, a signed 8-bit integer, and the higher order portion and the lower order portion together form a signed int4/5-encoded integer.

In some embodiments, the arithmetic circuit includes a multiplier circuit configured to separately multiply the higher order portion and lower order portion.

The disclosed embodiments can also be realized as methods, design structures, and program products.

### BRIEF DESCRIPTION OF THE DRAWINGS

FIG. 1 is a high-level block diagram of an exemplary data processing system including a processor in accordance with one embodiment;

FIG. 2 is a high-level block diagram of an exemplary artificial intelligence processing unit (AIPU) in accordance with one embodiment;

FIGS. 3A and 3B illustrate two exemplary multipliers having a common datapath for small and large (e.g., 4-bit and 8-bit) integer operands;

FIGS. 4A and 4B respectively depict bit sparsity for conventional int4/5 integer encoding and the disclosed innovative int4/5 integer encoding;

FIG. 5 is a high-level block diagram of a multiplexing circuit that can be implemented within an encoder in order to encode an integer in the int4/5 encoding disclosed herein;

FIG. 6 is a graph comparing power dissipation of a convolution operation for signed integers having magnitudes less than a threshold value for which the integer encoding is optimized; and

FIG. 7 is a design flow in accordance with at least one embodiment.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

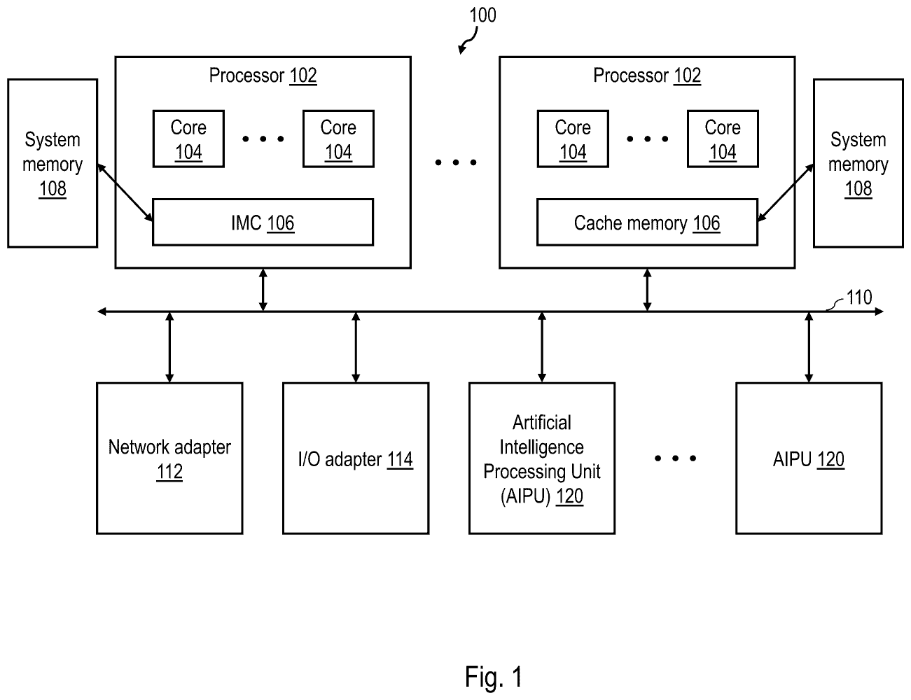

With reference now to the figures and in particular with reference to FIG. 1, there is illustrated a high-level block diagram of an exemplary data processing system 100 in accordance with one embodiment. In some implementations, data processing system 100 can be, for example, a mainframe computer system, a server computer system, a laptop or desktop personal computer system, a mobile computing device (such as a smartphone or tablet), an edge computing device (e.g., an Internet of Things (IoT) sensor or smart camera), or an embedded processor system.

As shown, data processing system 100 includes one or more processors 102 for processing instructions and data. Each processor 102 may be realized as a respective integrated circuit having a semiconductor substrate in which integrated circuitry is formed, as is known in the art. In at least some embodiments, processors 102 can generally implement any one of a number of commercially available processor architectures, for example, z/Architecture, POWER, ARM, Intel x86, NVidia, Apple silicon, etc. In the depicted example, each processor 102 includes one or more processor cores 104 for executing one or more simultaneous threads of execution and an integrated memory controller 106 providing processor cores 104 low latency access to instructions and operands in system memories 108. Processors 102 are coupled for communication by a system interconnect 110, which in various implementations may include one or more buses, switches, bridges, and/or hybrid interconnects.

Data processing system 100 also includes one or more artificial intelligence processing units (AIPUs) 120 configured for efficiently performing operations supporting artificial intelligence (AI) workloads, including machine learning (ML) and large language models (LLMs). In at least some embodiments, AIPUs 120 can be implemented with graphics processing units (GPUs). In at least some embodiments, a software stack executing on one or more of processor(s) 102 dispatches operations to AIPUs 120 to be performed. In other embodiments, the hardware circuitry represented by AIPUs 120 can be integrated in a common semiconductor substrate with one or more of processors 102.

Data processing system 100 may additionally include a number of other components coupled to system interconnect 110. These components can include, for example, a network adapter 112 for coupling data processing system 100 to a communication network (e.g., a wired or wireless local area network and/or the Internet) and an input/output (I/O) adapter 114 for coupling one or I/O devices to system interconnect 110. Those skilled in the art will additionally appreciate that data processing system 100 can include many additional non-illustrated components. Because such additional components are not necessary for an understanding of the described embodiments, they are not illustrated in FIG. 1 or discussed further herein. It should also be understood, however, that the enhancements described herein are applicable to data processing systems and processors of diverse architectures and are in no way limited to the generalized data processing system architecture illustrated in FIG. 1.

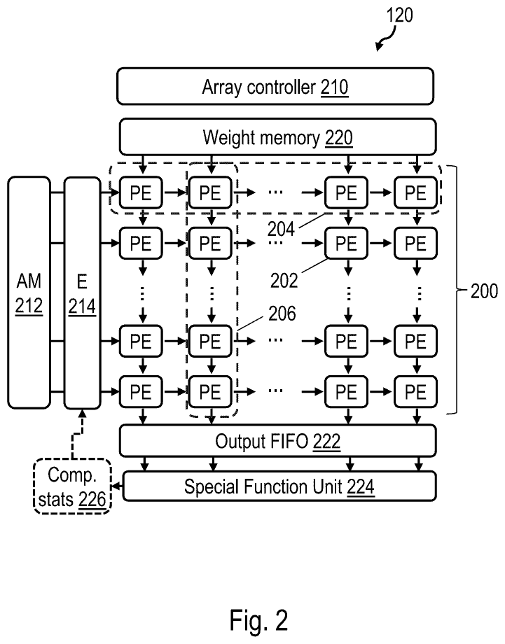

Referring now to FIG. 2, there is depicted a more detailed block diagram of an exemplary AIPU 120 in accordance with one embodiment. In this example, AIPU 120 includes a processing element (PE) array 200 formed of a grid or array of multiple processing elements (PEs) 202 arranged in multiple rows 204 and multiple columns 206. In at least some embodiments, each PE 202 is a relatively simple processor configured to perform basic arithmetic operations such as integer multiplication and addition. In other embodiments, PEs 202 may be configured to perform additional operations, such as floating-point arithmetic operations. PEs 202 operate in a largely synchronous, systolic manner under control of an array controller 210.

PE array 200 has an associated activation memory (AM) 212 that stores encoded activations (i.e., input data values) that are to be processed by PEs 202. Activation memory 206 can be organized, for example, as a plurality of activation memory banks each storing a vector of activations for a respective corresponding row 204 of PEs 202. Activations read out of activation memory 212 can be encoded by an encoder 214 in a suitable format for computation by PEs 202. For example, as discussed below, in some embodiments encoder 214 may selectively encode 8-bit integer operands (i.e., int8 formatted integers) into int4/5 format. PE array 200 also has a separate weight memory 220 that stores weight values used by PEs 202 for multiplication operations. In at least some embodiments, weight memory 220 can be organized, for example, with multiple weight memory banks, each storing a vector of weights for a corresponding column 206 of PEs 202.

In operation, controller 220 issues a sequence of control signals that cycles the activations and weight values through PE array 200 so that outputs can be systematically produced. For example, in a first control cycle, controller 220 may route an activation vector A and a weight vector W to the first row 204 and column 206 of PE array 200. PEs 202 perform A*W multiplication operations and accumulate the results with any stored values. In the next cycle, a different activation vector B and weight vector X are routed to the first row 204 and column 206. The PEs 206 multiply and accumulate B*X with the previous results. This cycling of different combinations of activation and weight vectors continues until a full cycle has been completed, producing a vector of partial outputs at each PE 202. The PEs 202 may then pass the partial outputs to a neighboring column 206 of PEs 202 in PE array 200 through a shift operation. Additional cycles feed new activations and weights from the memories 212, 220 to produce a series of output vectors that can be collected and provided downstream in a systolic fashion, that is, as input to another row 204 or as a final result of PE array 200 provided to output first-in, first-out (FIFO) buffer 222.

In at least some embodiments, AIPU 120 additionally includes a special function unit (SFU) 224 coupled to receive PE array results from output FIFO 222. SFU 224 can be configured to quantize intermediate floating-point values into integer values suitable for ingestion by one or more rows 204 of PE array 200. In addition, SU 224 can be configured to selectively perform one or more non-linear functions, like a rectified linear unit (ReLU) activation function. In accordance with at least some embodiments, SFU 224 may also be configured to determine computational statistics 226 regarding the floating-point values and/or integer values including, for example, the sign, magnitude, and number of ones/zeros in predetermined bits of the values. Computational statistics 226 may be utilized by hardware (e.g., encoder circuit 214) to control the encoding selectively performed by encoder 214, as discussed further below. The encoding selectively performed by encoder 214 may alternatively or additionally be controlled by software (e.g., by a compiler of the AI workload).

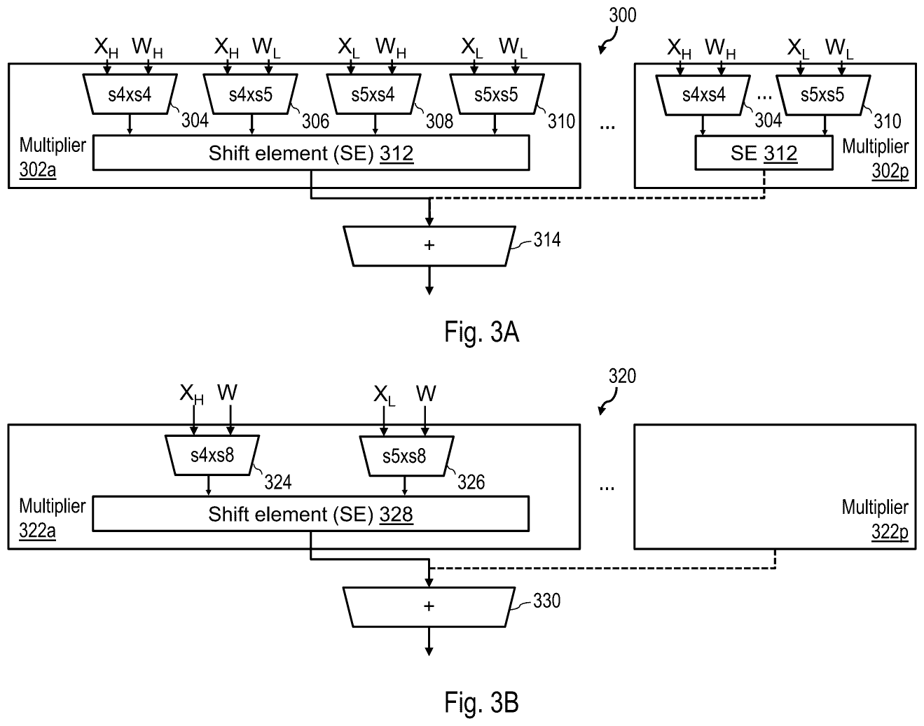

With reference now to FIGS. 3A and 3B, there are illustrated two different exemplary embodiments of multiplier circuits 300, 320 that can be utilized to partially or fully implement a processing element 202 of FIG. 2. In each of these examples, the multiplier circuit has a common datapath for small and large operands, which results in a lower combined leakage and promotes area-efficient circuit implementation as compared to circuits having separate datapaths for large and small operands. In at least some embodiments, the large operands have a bit width of N bits (permitting the representation of unsigned integers between −2^{N} and 2^{N}−1 and signed integers between −2^{N-1} and 2^{N-1}−1). The small operands have bit widths of N-M and M+1 bits, respectively, where the inclusion of the additional bit in the lower M+1 bits enables a signed large integer operand to be decomposed into two signed smaller integer operands. Although hereinafter it will be assumed for simplicity that N is 8 and M is 4, those skilled in the art will appreciate that these choices are arbitrary and that N and M can be selected to be any positive integers where N>M.

Referring specifically to FIG. 3A, multiplier circuit 300 includes P multipliers 302 (i.e., multipliers 302a, . . . , 302n), where P is a positive integer greater than or equal to one. In this example, each multiplier 302 includes four adders 304, 306, 308, and 310, which generate respective partial products that are received as inputs of a shift element (SE) 312. SE 312 is configured to perform appropriate shifting of the bits of the partial products produced by adders 304-310 to obtain an 8-bit product. The 8-bit product output by shift element 312 may optionally be further summed with the outputs of others of multipliers 302 by an output adder 314.

In the illustrated example, each multiplier 302 computes the product of two signed 8-bit integer operands X and W (i.e., int8 formatted integers), each of which is decomposed into a four-bit signed high portion (X_{H} or W_{H}) and a five-bit signed low portion (X_{L} or W_{L}). This decomposition is referred to in the art as int4/5 encoding. Thus, adder 304 computes the partial product of 4-bit high portions of operands X and W, adder 306 computes the partial product of 4-bit high portion of operand X and the 5-bit low portion of operand W, adder 308 computes the partial product of 5-bit low portion of operand X and the 4-bit high portion of operand W, and adder 310 computes the partial product of 5-bit low portions of operands X and W.

FIG. 3B illustrates a similar exemplary multiplier circuit 320 that can be utilized to partially or fully implement an alternative embodiment of a PE 202. In this example, multiplier circuit 320 includes P multipliers 322 (i.e., multipliers 322a, . . . , 322n), where P is a positive integer greater than or equal to one. In this example, each multiplier 322 includes two adders 324 and 326, which generate respective partial products that are received as inputs of a shift element (SE) 328. SE 328 is configured to perform appropriate shifting of the bits of the partial products produced by adders 324-326 to obtain an 8-bit product. The 8-bit product output by shift element 328 may optionally be further summed with the outputs of others of multipliers 322 by an output adder 330.

In the illustrated example, each multiplier 322 computes the product of signed 8-bit integer operands X and W (i.e., int8 formatted integers), where operand X is decomposed into int4/5 format and operand W remains in int8 format. In this example, adder 324 computes the partial product of the 4-bit high portion of operand X and operand W and adder 326 computes the partial product of 5-bit low portion of operand X and operand W.

The present application appreciates that the power dissipation of PEs 202 (and of processing array 200) is highly dependent on the percentage of bits of operands that switch states during processing. The present application appreciates that the percentage of bits of operands that switch states (and thus power dissipation) can be significantly reduced through judicious selection of the encoding performed by encoder 214.

In the prior art, a signed 8-bit integer (i.e., int8) operand {a₇a₆ . . . a₂a₁a₀} represents the integer −2\hat{ }a₇*128+unsigned {a₆ . . . a₂a₁a₀}, which can be represented in conventional int4/5 encoding as follows:

$$signed \{ {a}_{7} {a}_{6} {a}_{5} {a}_{4} \} ⋆ 16 + unsigned \{ {a}_{3} {a}_{2} {a}_{1} {a}_{0} \}$$

Utilizing this conventional int4/5 encoding, which includes a signed high portion and an unsigned low portion, a sampling of different signed positive and negative integer values can be represented in decimal and two's complement int8 and conventional int4/5 formats as shown in Table 1 below:

TABLE 1

int4/5

| | | Signed 4-bit high | Unsigned 5-bit low |
|---|---|---|---|
| Decimal | int8 | (decimal) | (decimal) |
| 13 | 00001101 | 0000 (0) | 01101 (13) |
| 109 | 01101101 | 0110 (6) | 01101 (13) |
| −14 | 11110010 | 1111 (−1) | 00010 (2) |
| −89 | 10100111 | 1010 (−6) | 00111 (7) |

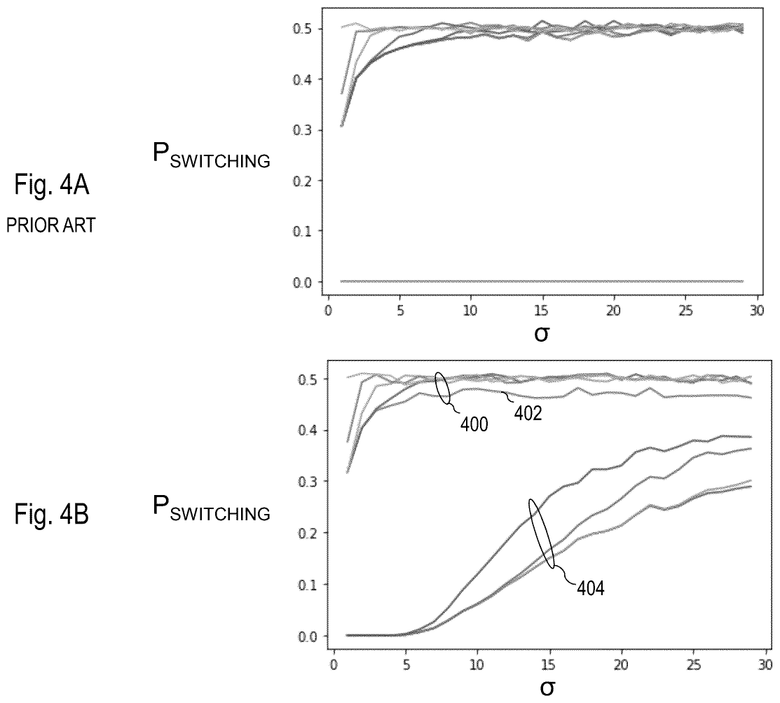

FIG. 4A is a graph depicting the probability of bit switching for each of 9 bits of conventional int4/5-formatted integer operands for a zero-mean Gaussian distribution of operands between negative 128 and positive 127 with varying sigma (o). As can be seen, the probability of all 9 bits of the integer operand switching states quickly approaches 0.5. Thus, even for small integer magnitudes, for example, integer operands between −15 and +15, the upper 4 bits still have 50% switching probability if the conventional int4/5 encoding is employed.

The present application appreciates that typical PE arrays 200 tend to process operands (e.g., activations and/or weights) bounded by magnitudes that are known a priori or that can be detected, for example, by SFU 224. For example, in some common AI networks, 50%-90% of activations have decimal values between −15 and +15. The present application leverages the bounded magnitude of a high percentage of activations to select a data encoding that reduces bit switching. For example, assuming signed int8-encoded operands of the format {a₇a₆ . . . a₂a₁a₀}, the integer operands can equivalently be int4/5 encoded as:

$$\{ signed \{ {a}_{7} {a}_{6} {a}_{5} {a}_{4} \} + {a}_{7} \} ⋆ 16 + signed \{ {a}_{7} {a}_{3} {a}_{2} {a}_{1} {a}_{0} \}$$

Utilizing this encoding, which employs a signed high portion and a signed low portion, a sampling of different signed positive and negative integer values can be represented in decimal and two's complement int8 and int4/5 formats as shown in Table 1 below:

TABLE 2

| | | int4/5 | |
|---|---|---|---|
| | | Signed 4-bit upper | Signed 5-bit lower |
| Decimal | int8 | (decimal) | (decimal) |
| 37 | 00100101 | 0010 (2) | 00101 (5) |
| 109 | 01101101 | 0110 (6) | 01101 (13) |
| −14 | 11110010 | 0000 (0) | 10010 (−14) |
| −89 | 10100111 | 1011 (−5) | 10111 (−9) |

As will be appreciated, for integer operand values between −15 and +15, this new int4/5 encoding causes the 4-bit upper portion of the integer operand to have a value of all zeros, meaning that a multiplication of the 4-bit upper portion will not result in any bit switching activity and thus reduces power dissipation. Of course, this same principle applies to other integer operand encodings that can be applied to integer operands having differing distributions of magnitudes. More generally, the number of bits in the lower portion (M+1) can be selected based on a threshold percentage of integer operands being predicted or detected to have a magnitude less than 2^{M}, such that an input N-bit operand can be encoded as a signed N-M bit higher order portion {a_{N-1}a_{N-2} . . . a_{N-M}} (representing the integer value [signed {a_{N-1} . . . a_{N-M}}+a_{N-1}]*2^{M}) and a signed M+1 bit lower order portion {a_{N-1}a_{N-M-1} . . . a₀} (representing the integer value signed {a_{N}a_{N-M-1} . . . a₀).

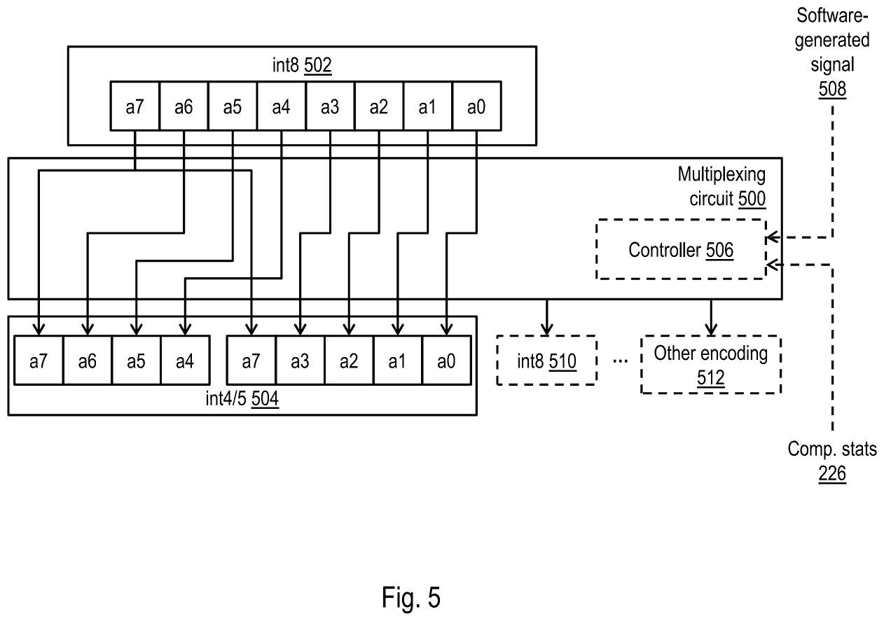

FIG. 5 is a high-level block diagram of a multiplexing circuit 500 that can be implemented within an encoder 214 in order to encode an integer in the int4/5 encoding 504 disclosed herein. In some implementations, encoder 214 may include a respective one of a plurality of instances of multiplexing circuit 500 for each row 204 of PE array 200. In some embodiments, multiplexing circuit 500 converts each signed int8-formatted integer operand 502 (represented in FIG. 5 by bits {a₇a₆ . . . a₂a₁a₀}) received as an input into a signed int4/5-formatted integer operand 504 having a signed 4-bit high portion {a₇a₆a₅a₄} representing the two's complement value {signed {a₇a₆a₅a₄}+a₇}*16} and a signed 5-bit low portion representing the two's complement value signed {a₇a₃a₂a₁a₀}.

In some other embodiments, multiplexing circuit 500 further includes a controller 506 that, based on control information received by multiplexing circuit 500, selects one of multiple output integer encodings (e.g., int4/5 encoding, int8 encoding, or another encoding 512) to be utilized for the output integer operand of multiplexing circuit 500. As indicated, in various implementations, this control information can include computational statistics 226 determined by SFU 224 and/or a software (e.g., compiler) generated signal 508. As one particular example, controller 506 may be configured to convert a signed int8-formatted integer operand 502 into a signed int4/5-formatted integer operand 504 based at least in part on computational statistics 226 indicating the percentage of integer operands having a magnitude less than a configured magnitude (e.g., 16) satisfies (e.g., is greater than) an encoding threshold. The percentage employed by controller 506 in this determination may further be configured such that the power dissipated by the encoding operation performed by multiplexing circuit 500 is less than the power savings achieved by utilizing integer operands encoded with the disclosed signed int4/5 format. This optimization ensures that the saving in power dissipation achieved as a result of the encoding the integer operands is not negated by the additional power dissipation required to perform the encoding. In cases in which the percentage of integer having a magnitude less than the configured value does not satisfy the encoding threshold, controller 506 may control multiplexing circuit 500 to simply refrain from applying a different encoding and pass through signed int8-formatted integer operand 502 to obtain signed int8-formatted integer operand 510. In other embodiments, in such cases, controller 506 may control multiplexing circuit 500 to apply a different encoding 512.

Referring now to FIG. 4B, there is depicted a graph depicting the probability of bit switching for each of 9 bits of the innovative int4/5-formatted integer operands for a zero-mean Gaussian distribution of operands between negative 128 and positive 127 with varying sigma (o). As represented by curves 400, the probability of the lower 5 bits of the integer operand switching states still approaches 0.5, with the curve 402 of the most significant (sign) bit of the lower 5 bits having a slightly lower probability of bit switching. However, as can be seen by comparison of FIG. 4B to FIG. 4A, the upper 4 bits, represented by curves 404, have a significantly lower switching probability than if the conventional int4/5 encoding is employed.

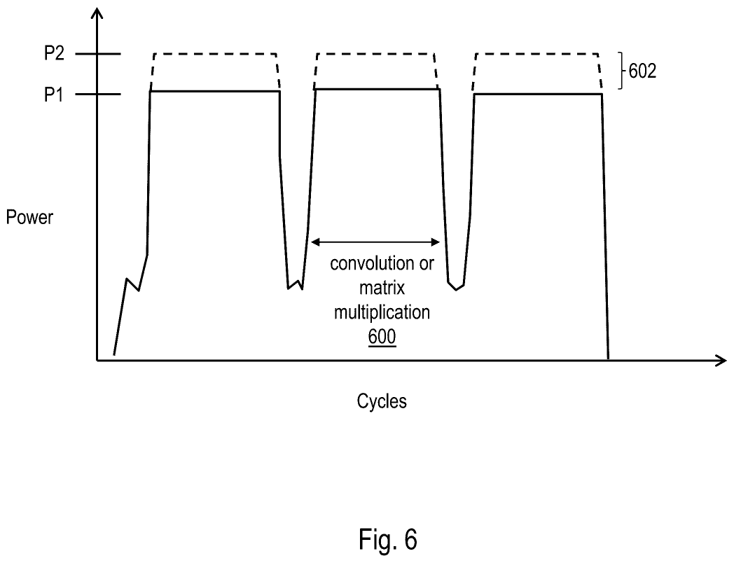

As a result of the lower switching probability of the upper four bits of signed int4/5 formatted integer operands, a significant reduction in the power dissipation of an AIPU 120 can be achieved. For example, FIG. 6 is a graph depicting power dissipation in a PE 202 of a systolic PE array 200 performing convolution or matrix multiplication operations utilizing signed integer operands, where processing cycles are represented along the X axis and power dissipation of the PE 202 is represented along the Y axis. In this example, a processing element performing convolution or matrix multiplication operations 600 dissipates power P2 if the conventional int4/5 encoding is utilized for the signed integer operands of the convolution or matrix multiplication operations; in contrast, a PE 202 of PE array 200 dissipates lower power P1 if encoder 214 encodes the signed integer operands of the convolution or matrix multiplication operations 600 with the int4/5 encoding disclosed herein. The difference 602 between power P2 and power P1 represents an approximately 10% reduction in peak power in PEs 202. It should be appreciated that additional reduction in power dissipation not depicted in FIG. 6 will be achieved in the signaling between PEs 202.

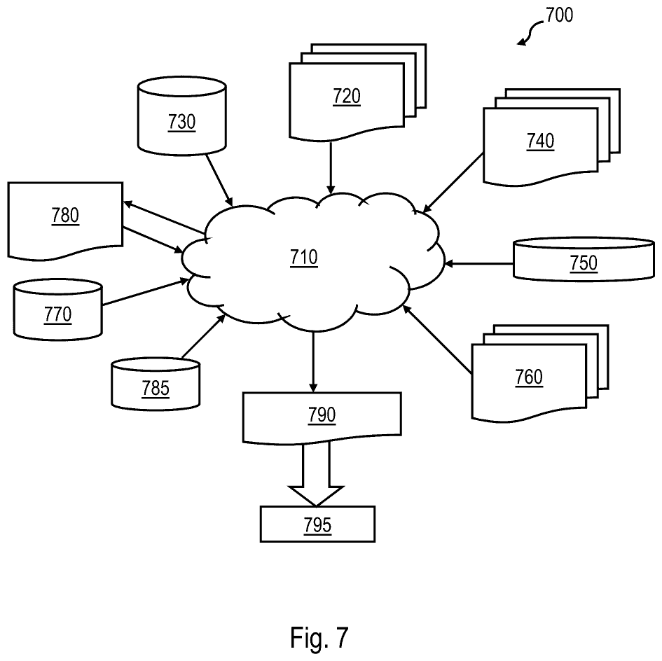

Referring now to FIG. 7, there is illustrated a block diagram of an exemplary design flow 700 used for example, in semiconductor IC logic design, simulation, test, layout, and manufacture. Design flow 700 includes processes, machines and/or mechanisms for processing design structures or devices to generate logically or otherwise functionally equivalent representations of the design structures and/or devices described above and shown herein. The design structures processed and/or generated by design flow 700 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 700 may vary depending on the type of representation being designed. For example, a design flow 700 for building an application specific IC (ASIC) may differ from a design flow 700 for designing a standard component or from a design flow 700 for instantiating the design into a programmable array, for example a programmable gate array (PGA) or a field programmable gate array (FPGA) offered by Altera® Inc. or Xilinx® Inc.

FIG. 7 illustrates multiple such design structures including an input design structure 720 that is preferably processed by a design process 710. Design structure 720 may be a logical simulation design structure generated and processed by design process 710 to produce a logically equivalent functional representation of a hardware device. Design structure 720 may also or alternatively comprise data and/or program instructions that when processed by design process 710, generate a functional representation of the physical structure of a hardware device. Whether representing functional and/or structural design features, design structure 720 may be generated using electronic computer-aided design (ECAD) such as is implemented by a core developer/designer. When encoded on a machine-readable data transmission, gate array, or storage medium, design structure 720 may be accessed and processed by one or more hardware and/or software modules within design process 710 to simulate or otherwise functionally represent an electronic component, circuit, electronic or logic module, apparatus, device, or system such as those shown herein. As such, design structure 720 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher-level design languages such as C or C++.

Design process 710 preferably employs and incorporates hardware and/or software modules for synthesizing, translating, or otherwise processing a design/simulation functional equivalent of the components, circuits, devices, or logic structures shown herein to generate a netlist 780 which may contain design structures such as design structure 720. Netlist 780 may comprise, for example, compiled or otherwise processed data structures representing a list of wires, discrete components, logic gates, control circuits, I/O devices, models, etc. that describes the connections to other elements and circuits in an integrated circuit design. Netlist 780 may be synthesized using an iterative process in which netlist 780 is resynthesized one or more times depending on design specifications and parameters for the device. As with other design structure types described herein, netlist 780 may be recorded on a machine-readable storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, or buffer space.

Design process 710 may include hardware and software modules for processing a variety of input data structure types including netlist 780. Such data structure types may reside, for example, within library elements 730 and include a set of commonly used elements, circuits, and devices, including models, layouts, and symbolic representations, for a given manufacturing technology (e.g., different technology nodes, 32 nm, 45 nm, 70 nm, etc.). The data structure types may further include design specifications 740, characterization data 750, verification data 760, design rules 790, and test data files 785 which may include input test patterns, output test results, and other testing information. Design process 710 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 710 without deviating from the scope and spirit of the invention. Design process 710 may also include modules for performing standard circuit design processes such as timing analysis, verification, design rule checking, place and route operations, etc.

Design process 710 employs and incorporates logic and physical design tools such as HDL compilers and simulation model build tools to process design structure 720 together with some or all of the depicted supporting data structures along with any additional mechanical design or data (if applicable), to generate a second design structure 790. Design structure 790 resides on a storage medium or programmable gate array in a data format used for the exchange of data of mechanical devices and structures (e.g., information stored in a IGES, DXF, Parasolid XT, JT, DRG, or any other suitable format for storing or rendering such mechanical design structures). Similar to design structure 720, design structure 790 preferably comprises one or more files, data structures, or other computer-encoded data or instructions that reside on transmission or data storage media and that when processed by an ECAD system generate a logically or otherwise functionally equivalent form of one or more of the embodiments of the invention shown herein. In one embodiment, design structure 790 may comprise a compiled, executable HDL simulation model that functionally simulates the devices shown herein.

Design structure 790 may also employ a data format used for the exchange of layout data of integrated circuits and/or symbolic data format (e.g., information stored in a GDSII (GDS2), GL1, OASIS, map files, or any other suitable format for storing such design data structures). Design structure 790 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown herein. Design structure 790 may then proceed to a stage 795 where, for example, design structure 790: proceeds to tape-out, is released to manufacturing, is released to a mask house, is sent to another design house, is sent back to the customer, etc.

As has been described, a processing unit includes a processing element (PE) array having a plurality of rows of PEs and a plurality of columns of PEs. Each of the PEs includes an arithmetic circuit configured to mathematically combine activation operands and weight operands. The PE array also includes a weight memory configured to supply weight operands to PEs in the PE array, an activation memory configured to supply activation operands to PEs in the PE array, and an encoder coupled to the activation memory. The encoder includes a multiplexing circuit configured to encode a signed N-bit input activation as a signed N-M bit higher order portion representing the integer value [signed {a_{N-1} . . . a_{N-M}}+a_{N-1}]*2^{M} and a signed M+1 bit lower order portion representing the integer value signed {a_{N}a_{N-M-1} . . . a₀}.

While various embodiments have been particularly shown and described, it will be understood by those skilled in the art that various changes in form and detail may be made therein without departing from the spirit and scope of the appended claims and these alternate implementations all fall within the scope of the appended claims.

Aspects of the present invention are described herein with reference to flowchart illustrations and/or block diagrams that illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Further, although aspects have been described with respect to a computer system executing program code that directs the functions of the present invention, it should be understood that present invention may alternatively be implemented as a program product including a computer-readable storage device storing program code that can be processed by a data processing system. The computer-readable storage device can include volatile or non-volatile memory, an optical or magnetic disk, or the like. However, as employed herein, a “storage device” is specifically defined to include only statutory articles of manufacture and to exclude signal media per se, transitory propagating signals per se, and energy per se.

The program product may include data and/or instructions that when executed or otherwise processed on a data processing system generate a logically, structurally, or otherwise functionally equivalent representation (including a simulation model) of hardware components, circuits, devices, or systems disclosed herein. Such data and/or instructions may include hardware-description language (HDL) design entities or other data structures conforming to and/or compatible with lower-level HDL design languages such as Verilog and VHDL, and/or higher-level design languages such as C or C++. Furthermore, the data and/or instructions may also employ a data format used for the exchange of layout data of integrated circuits and/or symbolic data format (e.g., information stored in a GDSII (GDS2), GL1, OASIS, map files, or any other suitable format for storing such design data structures).

The figures described above and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms and that multiple of the disclosed embodiments can be combined. Lastly, the use of a singular term, such as, but not limited to, “a” is not intended as limiting of the number of items.

What is claimed is:

1. A processing unit comprising:
a processing element (PE) array including a plurality of rows of PEs and a plurality of columns of PEs, wherein each of the PEs includes an arithmetic circuit configured to mathematically combine activation operands and weight operands;
a weight memory configured to supply weight operands to PEs in the PE array;
an activation memory configured to supply activation operands to PEs in the PE array; and
an encoder coupled to the activation memory and to the PE array, wherein the encoder includes a multiplexing circuit configured to encode a signed N-bit activation operand as a signed N-M bit higher order portion representing an integer value [signed {a_{N-1} . . . a_{N-M}}+a_{N-1}]*2^{M} and a signed M+1 bit lower order portion representing an integer value signed {a_{N}a_{N-M-1} . . . a₀}.

2. The processing unit of claim 1, wherein:
the encoder includes a controller configured to selectively control encoding of the signed N-bit input activation operand by the encoder based on control information.

3. The processing unit of claim 2, wherein:
the processing unit further comprises a special function unit circuit configured to determine computation statistics for the PE array; and
the control information includes the computation statistics.

4. The processing unit of claim 3, wherein:
the computation statistics include an indication of whether a percentage of operands having a magnitude less than a configured value satisfies an encoding threshold.

5. The processing unit of claim 2, wherein the control information includes a software-generated signal.

6. The processing unit of claim 1, wherein:
the signed N-bit input activation is a signed 8-bit integer; and
the higher order portion and the lower order portion together form a signed int4/5-encoded integer.

7. The processing unit of claim 1, wherein the arithmetic circuit includes a multiplier circuit configured to separately multiply the higher order portion and lower order portion.

8. A design structure tangibly embodied in a machine-readable storage device for designing, manufacturing, or testing an integrated circuit, the design structure comprising:
a processing unit including:
a processing element (PE) array including a plurality of rows of PEs and a plurality of columns of PEs, wherein each of the PEs includes an arithmetic circuit configured to mathematically combine activation operands and weight operands;
a weight memory configured to supply weight operands to PEs in the PE array;
an activation memory configured to supply activation operands to PEs in the PE array; and
an encoder coupled to the activation memory and to the PE array, wherein the encoder includes a multiplexing circuit configured to encode a signed N-bit activation operand as a signed N-M bit higher order portion representing an integer value [signed {a_{N-1} . . . a_{N-M}}+a_{N-1}]*2^{M} and a signed M+1 bit lower order portion representing an integer value signed {a_{N}a_{N-M-1} . . . a₀}.

9. The design structure of claim 8, wherein:
the encoder includes a controller configured to selectively control encoding of the signed N-bit input activation operand by the encoder based on control information.

10. The design structure of claim 9, wherein:
the processing unit further comprises a special function unit circuit configured to determine computation statistics for the PE array; and
the control information includes the computation statistics.

11. The design structure of claim 10, wherein:
the computation statistics include an indication of whether a percentage of operands having a magnitude less than a configured value satisfies an encoding threshold.

12. The design structure of claim 9, wherein the control information includes a software-generated signal.

13. The design structure of claim 8, wherein:
the signed N-bit input activation is a signed 8-bit integer; and
the higher order portion and the lower order portion together form a signed int4/5-encoded integer.

14. The design structure of claim 8, wherein the arithmetic circuit includes a multiplier circuit configured to separately multiply the higher order portion and lower order portion.

15. A method of processing in a processing unit including a plurality of processing elements (PEs) arranged in a PE array, the method comprising:
storing, in a weight memory, weight operands for PEs in the PE array;
storing in an activation memory, activation operands for PEs in the PE array;
encoding the activation operands by an encoder coupled to the activation memory and to the PE array, wherein the encoding includes encoding a signed N-bit activation operand as a signed N-M bit higher order portion representing an integer value [signed {a_{N-1} . . . a_{N-M}}+a_{N-1}]*2^{M} and a signed M+1 bit lower order portion representing an integer value signed {a_{N}a_{N-M-1} . . . a₀}; and
processing the encoded activation operand in the PE array, wherein the processing includes mathematically combining the encoded activation operand with a weight operand.

16. The method of claim 15, further comprising:
selectively controlling encoding of activation operands by the encoder based on control information.

17. The processing unit of claim 16, further comprising:
determining, by a special function unit circuit, computation statistics for the PE array, wherein the control information includes the computation statistics.

18. The processing unit of claim 17, wherein:
the computation statistics include an indication of whether a percentage of operands having a magnitude less than a configured value satisfies an encoding threshold.

19. The processing unit of claim 16, wherein the control information includes a software-generated signal.

20. The processing unit of claim 15, wherein:
the signed N-bit input activation is a signed 8-bit integer; and
the higher order portion and the lower order portion together form a signed int4/5-encoded integer.
